(19) United States
(12) Patent Application Publication
(10) Pub. No.: US 2024/0344971 A1
(43) Pub. Date: Oct. 17, 2024

(54) METHOD FOR ESTIMATING THE SIZE OF A SURFACE DEFECT OF A BEARING, AND ASSOCIATED BEARING DEVICE

(71) Applicant: Aktiebolaget SKF, Göteborg (SE)

(72) Inventors: Elizabertus MALJAARS, Houten (NL); Hendrik Anne MOL, Varik (NL); Gerrit-Jan DOP, Alphen aan den Rijn (NL); Johannes RAVESLOOT, Utrecht (NL); Arjen Cornelis Franciscus JANSSEN, Neerkant (NL)

(21) Appl. No.: 18/623,427

(22) Filed: Apr. 1, 2024

(30) Foreign Application Priority Data
Apr. 12, 2023 (DE) 102023203298.8

(51) Int. Cl. G01N 19/08; G01L 5/00

(52) U.S. Cl. CPC G01N 19/08; G01L 5/0019

(57) ABSTRACT

A device (8) for estimating the size of a surface defect of a bearing (6). The device (8) includes a conditioning means (13), a first determining means (14), a second determining means (15), a solving means (16), a comparing means (17), a detecting means (18), and a third determining means (19).

### CROSS-REFERENCE TO RELATED APPLICATION

This application claims priority to German Application No. 102023203298.8, filed Apr. 12, 2023, the entirety of which is hereby incorporated by reference.

### FIELD

The present disclosure relates to monitoring of rolling bearings.

More particularly, the present disclosure deals with a method and a device for estimating the size of a surface defect of a bearing.

The present disclosure further relates to a bearing device comprising such a device.

### SUMMARY

Known acceleration-based vibration condition monitoring methods of the bearing are based on vibration signals detected by sensors attached on the bearing or surrounding the bearing.

The sensors are connected to monitoring devices implementing condition monitoring methods.

The methods permit to detect and identify a defect of the bearing, and to evaluate the defect severity by estimating the size of a surface defect of bearings base on vibration signals.

The identification of a defect of the bearing is based on a comparison of the vibration signatures with known vibration signatures of bearing defects.

The evaluation of the defect severity is based on processing the vibration signals to detect the amplitude of the cyclostationary vibration excitations caused by the over rolling defects in bearings.

It is known that scalability between different machines comprising the sensors, and reproducibility on copies of same machine designs has been poor for acceleration-based vibration condition monitoring.

Further, severity quantification of a surface defect has not been robustly feasible using the common condition monitoring techniques such as acceleration-based vibration.

Moreover, known acceleration-based vibration condition monitoring methods have in common that they have been proven to work on clean laboratory equipment data but that in real conditions, to monitor bearings in machines, the presence of disturbances, the dynamics of the said machines and generally the deteriorated transfer paths of the vibrations from the source of vibrations to the sensors are blurring the defect signatures which may hide the defect signatures.

Consequently, the present disclosure intends to improve the accuracy of condition monitoring of a rolling bearing to enhance the evaluation of defect severities.

### SUMMARY

According to an aspect, a method for estimating the size of a surface defect of a bearing, the bearing comprising a stationary ring and a rotating ring capable of rotating concentrically relative to the stationary ring, and rolling elements interposed between the stationary and rotating rings, the method comprising:
measuring, with at least one strain sensor comprising a detection cell, the length of the detection cell of the sensor in a circumferential direction being smaller than the circumferential distance between two adjacent rolling elements projected on the stationary ring, strain values caused by rolling element forces on the stationary ring according to one position parameter comprising a rolling element position parameter representative of the position of the rolling elements relative to the at least one strain sensor, in particular spread in a loaded zone of the bearing,
determining intervals of position parameter values when rolling element position parameter values are associated to a maximum strain magnitude within a predetermined value, the maximum strain magnitude being equal to the maximum value of the strain values, the length of each interval being equal to a predetermined length,
determining a linear equation between the strain magnitudes of the intervals of position parameter values, a carrier function, and cyclostationary contact forces applied on at least one of the stationary ring, the rotating ring or rolling elements,
solving the linear equation to determine the cyclostationary contact forces applied on said at least one of the stationary ring, the rotating ring or rolling elements,
comparing the determined cyclostationary contact forces to a detection threshold,
detecting a surface defect on said at least the stationary ring, the rotating ring or rolling elements if the value of the cyclostationary contact forces is smaller than the detection threshold, and
determining the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

The method may be used to track multiple defects in the same bearing.

The entrance effect of the rolling element in a surface defect comprising a spall has much better visibility in strain domain than when observed with vibration. When the rolling element exits the spall, a disproportional effect on vibration is observed which is reduced by observing the strain compared to vibration.

The estimation of the cyclostationary contact forces permits to accurately predict the risk of failure of the bearing.

Advantageously, determining the linear equation and solving the linear equation comprises:
modelling the strain values with basis functions and basis function coefficients to obtain the carrier function,
for each interval, parametrizing the linear equation with basis functions and the at least one position parameter,
solving the parametrized equation to determine the basis coefficients, and
determining the cyclostationary contact forces from the basis coefficients and the strain values of each interval.

Preferably, determining the linear equation and solving the linear equation comprises:
determining a stabilizing equation to constraint the magnitude of cyclostationary contact forces and the inverse of the carrier function,
solving the linear equation taking into account the stabilizing equation to determine the basis coefficients of the cyclostationary contact forces and the inverse of the carrier function, and
determining the cyclostationary contact forces from the basis coefficients and the strain values of each interval.

Advantageously, the basis functions are B-splines or other functions having a local support.

Preferably, the position parameter further comprises the angular positions of the stationary and rotating rings relative to the rolling elements, and wherein the method comprises determining the cyclostationary contact forces applied on the rotating ring.

Advantageously, the bearing further comprises at least one cage to maintain the circumferential spacing of the rolling elements, the position parameter further comprises the angular positions of the cage relative to the stationary ring, and wherein the method comprises determining the cyclostationary contact forces applied on rolling elements.

Preferably, the position parameter further comprises the angular positions of the rolling elements relative to the stationary ring, and wherein the method comprises determining the cyclostationary contact forces applied on the stationary ring.

Advantageously, the method further comprises predicting the propagation of the detected surface defect from the cyclostationary contact forces, the size of the surface defect, and a prediction model.

According to another aspect, a device for estimating the size of a surface defect of a bearing is proposed.

The bearing comprises a stationary ring and a rotating ring capable of rotating concentrically relative to the stationary ring, and rolling elements interposed between the stationary and rotating rings.

The device comprises:
conditioning means configured to determine strain values from signals delivered by at least one strain sensor comprising a detection cell, the length of the detection cell of the sensor in the circumferential direction being smaller than the circumferential distance between two adjacent rolling elements projected on the stationary ring, the strain values being caused by rolling element forces on the stationary ring, and to associate each strain value to at least one position parameter value comprising a rolling element position parameter representative of the position of the rolling elements relative to the at least one strain sensor,
first determining means configured to determine intervals of position parameter values when rolling element position parameter values are associated to a maximum strain magnitude within a predetermined value, the maximum strain magnitude being equal to the maximum value of the strain values, the length of each interval being equal to a predetermined length,
second determining means configured to determine a linear equation between the strain magnitudes of the intervals of position parameter values, a carrier function, and cyclostationary contact forces applied on at least one of the stationary ring, the rotating ring or rolling elements,
solving means configured to solve the linear equation to determine the cyclostationary contact forces applied on said at least one of the stationary ring, the rotating ring or rolling elements,
comparing means configured to compare the determined cyclostationary contact forces to a detection threshold,
detecting means configured to detect a surface defect on said at least the stationary ring, the rotating ring or rolling elements if the value of the cyclostationary contact forces is smaller than the detection threshold, and
third determining means configured to determine the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

According to another aspect, a bearing device provided with a bearing including a stationary ring and a rotating ring capable of rotating concentrically relative to one another, and rolling elements interposed between the stationary and rotating rings, with at least one first strain sensor disposed on the stationary ring or on the rotating ring, and with a device as defined above connected to the at least one first strain sensor is proposed.

The first strain sensor comprises a detection cell, the length of the detection cell of the sensor in the circumferential direction being smaller than the circumferential distance between two adjacent rolling elements projected on the stationary ring.

Advantageously, the first strain sensor is disposed on the stationary ring, in the loaded zone of the bearing, the device being configured to determine defects on the rotating ring and the rolling elements.

Preferably, the bearing device further comprises a second strain sensor disposed on the stationary ring at the opposite of the strain sensor.

Advantageously, the bearing device comprises a plurality of strain sensors disposed on the stationary ring, the circumferential distance between two adjacent strain sensors been determined according to the circumferential distance between two rolling elements and the position parameter values of each interval.

Preferably, the plurality of strain sensors comprises at least Z+1 sensors, Z been the number of rolling elements.

Advantageously, the bearing device further comprises a second strain sensor, the first strain sensor being disposed on the stationary ring and the second strain sensor being disposed on the rotating ring.

According to another aspect, a rotating machine comprising a bearing device as defined above is proposed.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a machine according to the present disclosure,

FIG. 2 illustrates schematically an example of a bearing device according to the present disclosure,

FIG. 3 illustrates a first example of a method for estimating the size of a surface defect of the bearing according to the present disclosure,

FIG. 4 illustrates an example of cyclostationary contact forces according to a position parameter according to the present disclosure,

FIG. 5 illustrates a second example of a method for estimating the size of a surface defect of the bearing according to the present disclosure,

FIG. 6 illustrates a first example of a grid of strain sensors disposed on a bearing according to the present disclosure,

FIG. 7 illustrates an example of a temporal evolution of the signals delivered by an example of grid of strain sensors according to the present disclosure,

FIGS. 8 and 9 illustrates a second example of a grid of strain sensors disposed on a bearing according to the present disclosure,

FIG. 10 illustrates a first example of a grid of strain sensors disposed on a bearing to detect defects on the stationary ring, the rotating ring, and the rolling elements of the bearing according to the present disclosure, and

FIG. 11 illustrates a second example of a grid of strain sensors disposed on a bearing to detect defects on the stationary ring, the rotating ring, and the rolling elements of the bearing according to the present disclosure.

### DETAILED DESCRIPTION

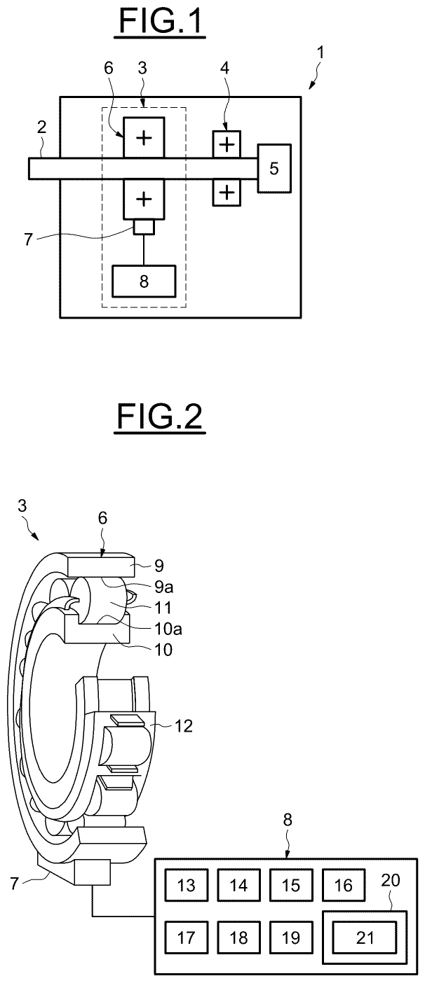

Reference is made to FIG. 1 which represents an example of a machine 1.

The machine 1 comprises a shaft 2 maintained in rotation by a bearing device 3 and a bearing 4.

The shaft 2 is for example driven by an electrical motor 5.

The bearing device 3 comprises a bearing 6, at least one strain sensor 7 disposed on the bearing 6 to measure strain values in the most loaded zone of the bearing 6, and a device 8 connected to the strain sensor 7.

The device 8 is connected to the sensor 7 with a wired connection or a wireless connection.

As represented on FIG. 1, the device 8 is located inside the machine 1.

In variant, the device 8 may be located outside the machine 1.

FIG. 2 illustrates schematically an example of the bearing device 3.

The bearing 3 including a stationary ring 9 and a rotating ring 10 capable of rotating concentrically relative to one another.

It is assumed that the stationary ring 9 is the outer ring of the bearing 3 and the rotating ring 10 is the inner ring of the bearing 3, the inner ring tightening the shaft 2.

The stationary ring 9 comprises a raceway 9a and the rotating ring 10 comprises a raceway 10a.

The bearing 6 further comprises rolling elements 11 interposed between the stationary and rotating rings 9, 10, and rolling on the raceways 9a, 10a of the stationary and rotating rings 9, 10.

At least one cage 12 maintains the circumferential spacing of the rolling elements 11.

The length of a detection cell of the sensor 7 in a circumferential direction is smaller than the circumferential distance between two adjacent rolling elements projected on the stationary ring in order to maintain a strong localized strain waveform related to the nearest rolling element contact force.

As represented on FIG. 2, the rolling elements 11 are rollers.

In variant, the rolling elements 11 may be balls.

The bearing 3 includes one raw of rolling elements 11. In variant, the bearing 3 may include more than one raw of rolling elements 11.

The device 8 comprises conditioning means 13, first determining means 14, second determining means 15, solving means 16, comparing means 17, detecting means 18, and third determining means 19.

The device 8 may further comprise predicting means 20 comprising a prediction model 21.

The predicting means 20 are located inside the device 8.

In variant, the predicting means 20 are located outside the device 8.

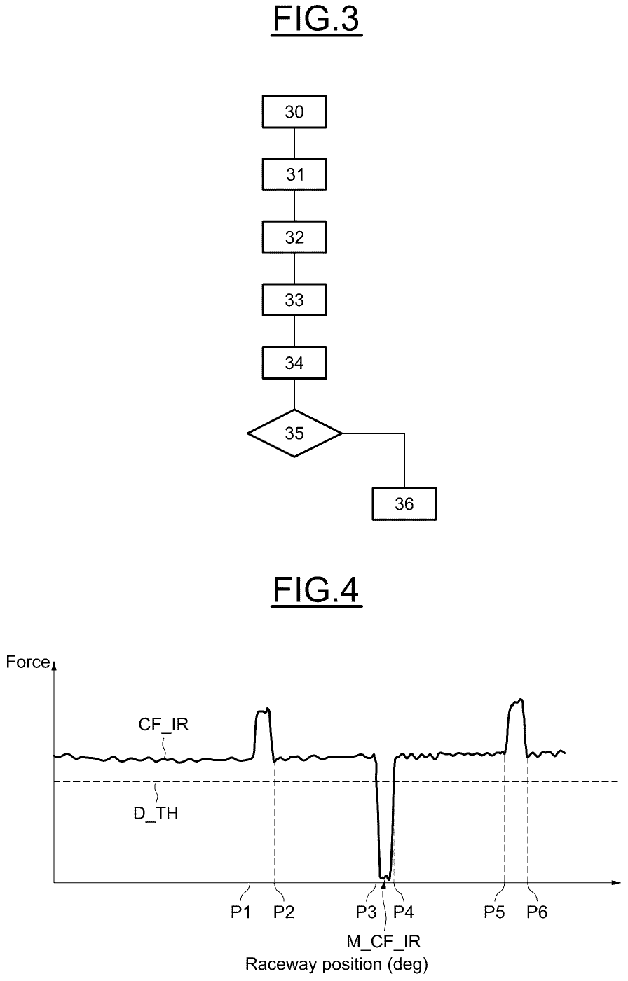

FIG. 3 illustrates a first example of a method for estimating the size of a surface defect of the bearing 6.

The method implements the device 8.

The surface defect may be located on the raceway 9a of the stationary ring 9, on the raceway 10a of the rotating ring 10, or on the outer surface of a rolling element 11 rolling on the raceways 9a, 10a of the stationary and rotating rings 9, 10.

In the following, it is assumed that the surface defect is located on the raceway 10a of the rotating ring 10, the method being implemented to detect the said surface defect.

Under constant rolling element force, the strain values measured by the strain sensor 7 is periodic and is function of a rolling element position parameter psi(t) representative of the position of the rolling elements relative to strain sensor 7.

The rolling element position parameter psi(t) depends on time t.

It is assumed that the contact force generated by the rolling element force on the rotating ring 10 is linear with the measured strain eps_local(t) depending on time so that:

$$eps\_local ( t ) = CA ( psi ( t ) ) * CF\_IR ( t ) \qquad ( 1 )$$

where CA is a carrier function and CF_IR(t) is the cyclostationary contact forces applied on the stationary ring 10.

In a step 30, the sensor 7 delivers signals comprising strain values caused by rolling element forces on the stationary ring 9.

In a step 31, the conditioning means 13 determine the strain values eps_local(t) from signals delivered by the strain sensor 7 and associate each strain value eps_local(t) to a position parameter value comprising the rolling element position parameter psi(t) and the angular position parameter IRphase of the stationary and rotating rings 9, 10 relative to the rolling elements 11.

In a step 32, the first determining means 14 determine intervals of position parameter values when values of the rolling element position parameter psi(t) are associated to a maximum strain magnitude eps_max within a predetermined value pv so that the intervals comprise measured strain values eps_local(t_vic) at the vicinity of the strain sensor 7.

$$eps\_local ( t\_vic ) = CA ( psi ( t\_vic ) ) * CF\_IR ( t\_vic ) \qquad ( 2 )$$

The predetermined value pv is chosen such that the strain values eps_local(t_vic) of each interval are taken in a circumferential distance equal for example to 10% of the rolling element distance between two adjacent rolling elements 11 and centered around the peak of the strain waveform delivered by the sensor 7.

The length of each interval is equal to a predetermined length equal for example to 20% of the rolling element distance.

In a step 33, the second determining means 15 determine a linear equation between the strain magnitudes of the intervals of position parameter values, the carrier function CA, and the cyclostationary contact forces CF_IR(t) applied on the rotating ring 10, and the solving means 16 solve the linear equation determined by the second determining means 15.

The second determining means 15 model the strain values eps_local(t) with basis functions in a matrix M_CA and basis function coefficients x_CA to obtain the carrier function CA.

The basis functions in the matrix M_CA are functions having a local support, for example B-splines obtained for example with the de Boor's algorithm.

Such functions allow reliable and unique estimations of the carrier CA and cyclostationary contact forces CF_IR(t) from the strain values.

In determining the carrier function CA it is assumed that all cyclostationary contact forces CF_IR(t) on the rotating ring 10 is a noise term having the property that it is a stochastic symmetric distribution with unit mean.

The matrix M_CA is determined from the following least squares problem:

$$eps\_local ( t\_vic ) = M\_CA ( psi ( t\_vic ) ) * x\_CA \qquad ( 3 )$$

The matrix M_CA is a full column rank matrix (having small condition number, e.g. less than 10) so that all basis function coefficients x_CA are uniquely estimated from the measured strain eps_local(t).

The carrier function CA as a function of the rolling element position parameter psi(t) in the vicinity of the sensor 7 is as follow:

$$CA ( psi ( t\_vic ) ) = M\_CA ( psi ( t\_vic ) ) * x\_CA \qquad ( 4 )$$

When the carrier function CA is determined, for each interval, the second determining means 15 parametrize the linear equation (1) with basis functions M_CA, the position parameter comprising the rolling element position parameter psi(t), and an angular position parameter RE_on_IR_phase.

The linear equation (2) in the vicinity of the sensor 7 is equal to:

$$Eps\_local ( t\_vic ) = CA ( psi ( t\_vic ) ) * CF\_IR ( t\_vic ) \\ CF\_IR ( t\_vic ) = M\_IR ( RE\_phase ( t\_vic ) ) * x\_IR \qquad ( 5 )$$

where cyclostationary contact forces CF_IR(t) on the rotating ring 10 is parametrized with the B-Splines, M_IR and x_IR are the basis function matrix and the basis function coefficients vector, and RE_on IR phase is the phases of the rolling elements 11 and the rotating ring 10 with respect to the position of the sensor 7 on the stationary ring 9 to take into account that the rolling element force is estimated at the point of contact between the stationary ring 9 and the rotating ring 10.

The parameter RE_on_IR phase is defined as follows:

$$RE\_on \_IR phase ( t\_vic ) = mod ( IRphase ( t\_vic ) - psi ( t\_vic ) / nRE , psi\_domain ) \qquad ( 6 )$$

where nRE is the number of rolling elements 11 in the bearing 6 and mod is an operator wrapping the signal at the chosen psi_domain (e.g. degrees or pi).

Equation (5) is rewritten as following:

$$Eps\_local ( t\_vic ) = \qquad ( 6 )$$

$$[ diag ( CA ( psi ( t\_vic ) ) ) * M\_IR ( RE\_on \_IR \_phase ( t\_vic ) ) * x\_IR ] * x\_IR$$

where the carrier psi(t_vic) is evaluated using equation (3).

Equation (6) is a least squares problem.

The solving means 16 solve equation (6) to determine the cyclostationary contact forces CF_IR(t) equal to M_IR(RE_on_IR phase(t_vic))*x_IR.

The cyclostationary contact forces CF_IR(t) are determined from the basis coefficients and the strain values of each interval.

In step 34, the comparing means 17 compare the determined cyclostationary contact forces CF_IR to a detection threshold D_TH.

If a value of the cyclostationary contact forces CF_IR is smaller than the detection threshold D_TH (step 35), the detecting means 18 detect that the rotating ring 10 has a surface defect.

Then the detecting means 18 have detected that the step 35 rotating ring 10 has a surface defect (step 36), the third determining means 19 determine the size of the surface defect from the intervals of position parameter from the position parameter values associated with cyclostationary contact forces smaller than the detection threshold D_TH.

FIG. 4 illustrates an example of the cyclostationary contact forces CF_IR according to the position parameter comprising the angular position of a reference point on the raceways 10a of the rotating ring 10 relative to the sensor 7 determined by the first example of a method for estimating the size of a surface defect of the bearing 6.

When the angular position is in the range [P1, P2] and [P5, P6], the cyclostationary contact forces CF_IR are higher than the mean value of the said contact forces.

When the angular position is in the range [P3, P4] the said contact forces are less than the mean value and the detection threshold D_TH.

The minimum level of the said contact forces is noted M_CF_IR and is due to rolling elements 11 rolling through a defect.

The level M_CF_IR is equal to or larger than zero as the rolling contact forces may not be completely lost.

The level M_CF_IR gives information about the depth and width of the defect.

As the cyclostationary contact forces CF_IR are less than the mean value and the detection threshold D_TH, the detecting means 18 detect the surface defect on the raceway 10a.

In this example, when the rolling elements 11 roll on the deep surface defect (range [P3, P4]), the rolling elements 11 do not enter in contact with the rotating ring 10 so the sensor 7 measures a strain nearly nil.

The cyclostationary contact forces CF_IR are higher in the range [P1, P2] and [P5, P6] to compensate the contact loss between the rolling elements 11 and the module ring 10.

The third determining means 19 determine the size of the surface defect.

The size of the surface defect is defined by three parameters represented for example by vectors.

A first vector defines the length of the size of the surface defect and is oriented in the rolling direction.

A second vector defines the width of the size of the surface defect and is oriented in the axial direction of the bearing.

The third vector defines the depth of the size of the surface defect and is oriented in the radial direction of the bearing, perpendicular to both the length vector and the width vector.

The depth of the size of the surface defect is determined from the level M_CF_IR.

Further the level M_CF_IR is used to track for example the propagation of a spall in the bearing.

The distance associated to the angular sector defined by the range [P3, P4] in which the contact forces CF_IR are below the detection threshold D_TH gives the length of the surface defect.

FIG. 5 illustrates a second example of the method for estimating the size of a surface defect of the bearing 6.

The second example of the method comprises the steps 30 to 32 as defined above.

In a step 37, the second determining means 15 determine a stabilizing equation to constraint the magnitude of cyclostationary contact forces CF_IR(t) on the rotating ring 10 and the inverse of the carrier function CA, and the solving means 16 solve the linear equation taking into account the stabilizing equation to determine the basis coefficients x_CA, the cyclostationary contact forces CF_IR(t), and the inverse CA_inv of the carrier function CA.

Starting from equation (2):

$$eps\_local ( t\_vic ) = CA ( psi ( t\_vic ) ) * CF\_IR ( t\_vic ) \qquad ( 2 )$$

this equation is rewritten in equation (7) as follow:

$$eps\_local ( t\_vic ) * CA\_inv ( psi ( t\_vic ) ) = CF\_IR ( t\_vic ) \qquad ( 7 )$$

The inverse carrier CA_inv and the cyclostationary contact forces CF_IR(t) are parameterised using for example B-splines/

Equation (7) is rewritten as follow:

$$( diag ( eps\_local ( t\_vic ) ) * M\_CA \_inv ( psi ( t\_vic ) ) ) * x\_CA \_inv = M\_IR ( IRphase ( t\_vic ) , psi ( t\_vic ) ) * x\_IR \qquad ( 7 )$$

where M_CA_inv is the matrix with basis functions for the inverse carrier parameterization and x_CA_inv is the corresponding basis function coefficients vector.

Equation (7) may be rewritten as follow:

$$A * x = b \qquad ( 8 )$$

where

$$A = [ diag ( eps\_local ( t\_vic ) ) * M\_CA \_inv ( psi ( t\_vic ) ) , \\ M\_IR ( IRphase ( t\_vic ) , psi ( t\_vic ) ) ] \qquad ( 9 )$$

and where x is a stacked vector of the form

$$x = [ x\_CA \_inv \hat{} Tx\_IR \hat{} T ] \hat{} T \qquad ( 10 )$$

However, one direction is unconstrained, basically the scaling of the inverse carrier CA_inv and the cyclostationary contact forces CF_IR, therefore an additional stabilizing equation A_stab*x=b (at least one row in A_stab that is spanning the null space of A) is added, to keeps the inverse carrier CA_inv close to one when the RE is below the sensor:

$$A\_final = [ AA\_stab ] , b\_final = [ bb\_stab ] and \\ A\_final * x\_final = b\_final \qquad ( 11 )$$

Solving equation (8) yields the estimates for the inverse carrier basis function parameters x_CA_inv.

The cyclostationary contact forces CF_IR may be evaluated using x_IR again at any desired grid. An additional weighting matrix W can be used to let the solution concentrate on the center of the carrier, resulting in a weighted least squares problem.

As this problem is well posed, it can also be written as a compact QP problem that can be solved when limited memory is available.

In the present example of a surface defect on the raceway 10a of the rotating ring 10, the cyclostationary force CF_IR include the contact forces on the rotating ring 10. In the general case, the cyclostationary force CF_IR is replaced by cyclostationary force CF_int which may also include the contact forces on the rotating ring 10 and the contact forces on the stationary ring 9 and/or rolling elements 11.

After the cyclostationary contact forces CF_IR are determined, the method continues with steps 34, 35, 36.

When the device 8 comprises the predicting means 20, the predicting means 20 predict the propagation of the detected surface defect from the cyclostationary contact forces CF_IR or CF_int, the size of the surface defect, and the prediction model 21.

The method may determine the cyclostationary contact forces applied on rolling elements 11 determine a surface defect on a rolling element 11, the position parameter further comprising the angular positions of the cage 12 relative to the stationary ring 9.

An observer may provide the rolling element defect frequency and the method may be used to determine the defect length.

This may give robust results on roller bearings, whereas the results on ball bearings are more intermittent and hence give more averaged results, still indicating the defect size.

Rolling element defects may be handled in the same way as rotating ring defects, assuming that an intermittent cyclostationary signature is visible with the duration of the interval.

The method may determine the cyclostationary contact forces applied on the stationary ring 9 to determine a surface defect on the stationary ring 9, the position parameter further comprising the angular positions of the rolling elements 11 relative to the stationary ring 9.

To detect a surface on the stationary ring 9, a suitable strain sensor configuration is needed, which is detailed below.

For the detection of a surface defect on the stationary ring 9, the first example of the method shall be used with a fixed (chosen or calibrated based on data or models) carrier.

The contributions of the cyclostationary contact forces applied on rolling elements 11 and of the cyclostationary contact forces applied on the stationary ring 10 may be added to equation (1) such that surface defects at multiple components (rolling elements 11, stationary ring 10) may be estimated simultaneously.

The phases of the rotating ring 10 and rolling element 11 position may be measured explicitly with additional sensors, e.g. magnetic sensors that feel the passage of the rolling element 11 and e.g. shaft encoders. The information is however also implicitly embedded in the strain signals and can be estimated simultaneously using a suitable observer, such as (Extended/Unscented) Kalman Filters or the construction of a (nonlinear) optimization problem that provides next to the carrier and cyclostationary force waveform also the phases of rotating components.

In the following, the position of at least the strain sensor 7 is exposed according to the component to be monitored.

As exposed, to determine a surface defect on the rotating ring 10, the strain sensor 7 is disposed on the stationary ring 9 on the most loaded zone of the bearing 6.

To determine a surface defect on rotating elements 11, the strain sensor 7 is disposed on the stationary ring 9 on the most loaded zone of the bearing 6.

To detect a defect on the stationary ring 9, a plurality of strain sensors are disposed on the stationary ring 9.

The circumferential distance between two adjacent strain sensors is determined according to the circumferential distance between two rolling elements 11 and the position parameter values of each interval.

To achieve sufficiently observability, a grid of strain sensors is needed within a rolling element 11 distance near the top of the loaded zone. The circumferential distance between two rolling elements 11 is dictated by minimal the ceiling of the following ratio: rolling element distance RE_D on the stationary ring raceway 9a over the localized strain footprint width psi_vic. Here, the latter being the psi_vic converted in mm distance on the stationary ring raceway 9a. This grid of sensors can be part of a more extensive sensor configuration with several of these groups in order to deal with loaded zone changes.

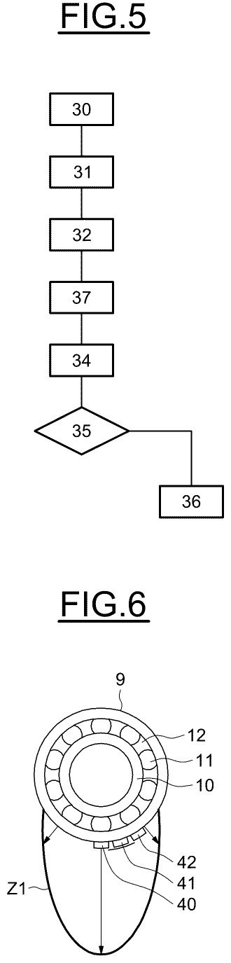

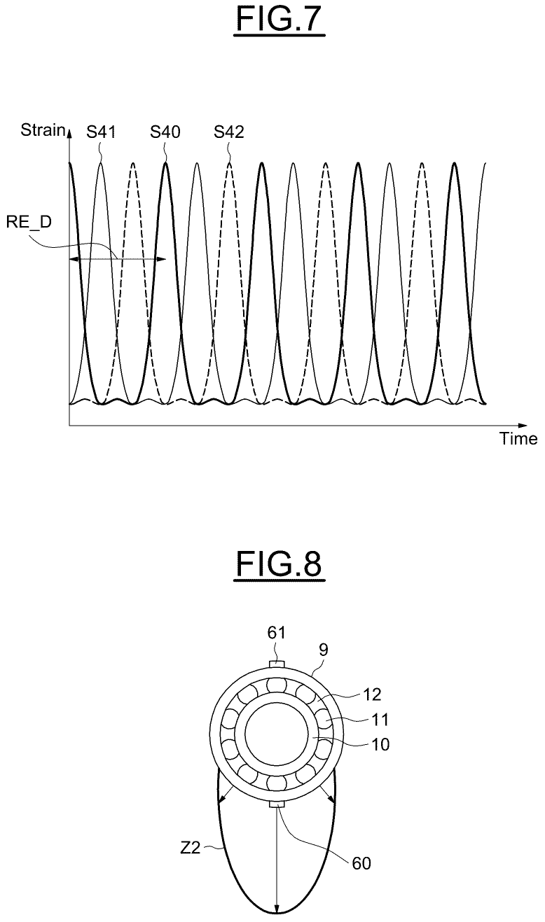

The sensor configuration is illustrated on FIGS. 6 and 7.

FIG. 6 illustrates a first example of a grid of strain sensors 40, 41, 42 disposed in the loaded zone Z1 to detect a defect on the stationary ring 9.

The strain sensors 40, 41, 42 are disposed on the stationary ring 9 as explained above.

FIG. 7 illustrates an example of a temporal evolution of the signals S40, S41, S42 delivered respectively by the sensors 40, 41, 42.

The sensors 40, 41, 42 are disposed on the stationary ring 10 so that the overlap of the signals S40, S41, S42 is sufficient, the overlap is governed by the rolling element distance RE_D over the localized strain footprint width psi_vic.

In the presence of multiple loaded zones which may switch over time for example in a gearbox, a strain sensor may be disposed in each loaded zone to determine a surface defect on the rotating ring 10 and/or rolling elements 11.

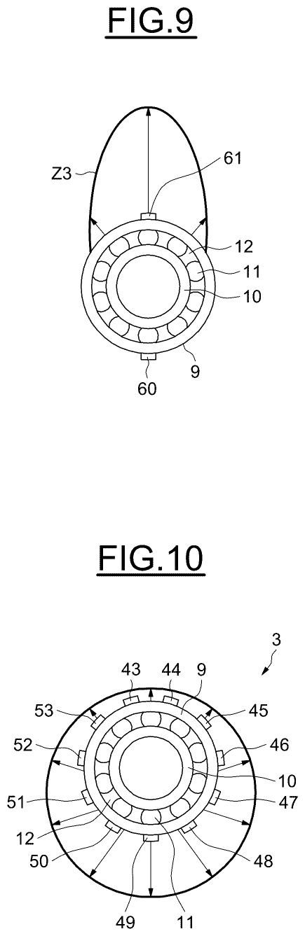

FIGS. 8 and 9 illustrates a second example of a grid of strain sensors 60, 61 disposed on the stationary ring 9 in a first loaded zone Z2 and a second loaded zone Z3 to detect a defect on the stationary ring 9, for example in a gearbox.

The first loaded zone Z2 and the second loaded zone Z3 switch over time.

In this example, the first strain sensor 60 is disposed in the first loaded zone Z2 and the second strain sensor 61 is disposed in the second loaded zone Z3 opposite of the first strain sensor 60.

The load transfer from the rolling element loosing contact force due to defect to the other rolling elements in the loaded zone near the sensor(s) needs to be taken into account.

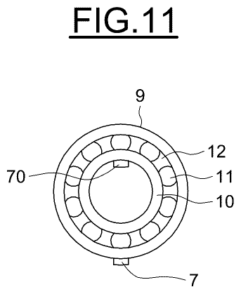

FIG. 10 illustrates a first example of a grid of strain sensors to detect defects on the stationary ring 9, the rotating ring 10, and the rolling elements 11.

The example of the grid of strain sensors comprises Z+1 sensors, Z being the number of rolling elements 11.

In this example, the bearing 3 is full loaded and comprises ten rolling elements 11 and the grid of strain sensors comprises eleven strain sensors 43, 44, 45, 46, 47, 48, 49, 50, 51, 52, 53 regularly disposed on the stationary ring 10.

When the loaded zone does not span the full circumference, the strain sensors are disposed on the stationary ring 9 in the loaded zone, the number of strain sensors being equal to the number of rolling elements 11 in the loaded zone plus one.

The entrance effect of the rolling element 11 in a surface defect comprising a spall has much better visibility in strain domain than when observed with vibration. When the rolling element 11 exits the spall, a disproportional effect on vibration is observed which is reduced by observing the strain compared to vibrations.

The exit contact force looks much more similar to the entry contact force than the vibration response does. The main transfer function between sensor and excitation sources (rolling elements 11) as in vibration is avoided. High frequent resonances dominate acceleration response.

The signature does not change significantly with running speed and load. Deterministic excited rigid body modes are modestly present in the reconstructed load waveforms. The magnitude of the excitation depends on the load and is easy to handle in signal processing. As such the method is scalable to all speed ranges. It is also well applicable at very low speeds where acceleration often fails and provided a sufficiently long observation time that reveals the cyclostationary behaviour of interest.

The estimation of the cyclostationary contact forces permits to accurately predict a risk of failure of the bearing 3.

In the second example of the method, a single recording is sufficient to provide the defect size estimate.

The method may be used to track multiple defects in the same bearing.

FIG. 11 illustrates a second example of a grid of strain sensors to detect defects on the stationary ring 9, the rotating ring 10, and the rolling elements 11.

The second example of the grid of strain sensors comprises the strain sensor 7 disposed on the stationary ring 9 and a second strain sensor 70 disposed on the rotating ring 10.

The strain sensor 7 monitors the rotating ring 10 and the rolling elements 11, and the second strain sensor 70 monitors the stationary ring 9 and the rolling elements 11.

The strain sensor 7 and the second strain sensor 70 permit to monitor and detect a defect on the stationary ring 9, the rotating ring 10, and the rolling elements 11.

What is claimed is:

1. A method for estimating the size of a surface defect of a bearing, the bearing comprising a stationary ring and a rotating ring capable of rotating concentrically relative to the stationary ring and rolling elements interposed between the stationary and rotating rings, the method comprising:
measuring, with at least one strain sensor comprising a detection cell, the length of the detection cell of the sensor in the circumferential direction being smaller than the circumferential distance between two adjacent rolling elements projected on the stationary ring, strain values caused by rolling element forces on the stationary ring according to one position parameter comprising a rolling element position parameter representative of the position of the rolling elements relative to the at least one strain sensor, in particular spread in a loaded zone of the bearing,
determining intervals of position parameter values when rolling element position parameter values are associated to a maximum strain magnitude within a predetermined value, the maximum strain magnitude being equal to the maximum value of the strain values, the length of each interval being equal to a predetermined length,
determining a linear equation between the strain magnitudes of the intervals of position parameter values, a carrier function, and cyclostationary contact forces applied on at least one of the stationary ring, the rotating ring or rolling elements,
solving the linear equation to determine the cyclostationary contact forces applied on said at least one of the stationary ring, the rotating ring or rolling elements,
comparing the determined cyclostationary contact forces to a detection threshold,
detecting a surface defect on said at least the stationary ring, the rotating ring or rolling elements if the value of the cyclostationary contact forces is smaller than the detection threshold, and
determining the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

2. The method according to claim 1, wherein determining the linear equation and solving the linear equation comprises:
modelling the strain values with basis functions and basis function coefficients to obtain the carrier function,
for each interval, parametrizing the linear equation with basis functions and the at least one position parameter,
solving the parametrized equation to determine the basis coefficients, and
determining the cyclostationary contact forces from the basis coefficients and the strain values of each interval.

3. The method according to claim 1, wherein determining the linear equation and solving the linear equation comprises:
determining a stabilizing equation to constraint the magnitude of cyclostationary contact forces and the inverse of the carrier function,
solving the linear equation taking into account the stabilizing equation to determine the basis coefficients of the cyclostationary contact forces and the inverse of the carrier function, and
determining the cyclostationary contact forces from the basis coefficients and the strain values of each interval.

4. The method according to claim 2, wherein the basis functions are B-splines or other functions having a local support.

5. The method according to claim 1, wherein the position parameter further comprises the angular positions of the stationary and rotating rings relative to the rolling elements, and wherein the method comprises determining the cyclostationary contact forces applied on the rotating ring.

6. The method according to claim 1, the bearing further comprising at least one cage to maintain the circumferential spacing of the rolling elements, wherein the position parameter further comprises the angular positions of the cage relative to the stationary ring, and wherein the method comprises determining the cyclostationary contact forces applied on rolling elements.

7. The method according to claim 1, wherein the position parameter further comprises the angular positions of the rolling elements relative to the stationary ring, and wherein the method comprises determining the cyclostationary contact forces applied on the stationary ring.

8. The method according to claim 1, further comprising predicting the propagation of the detected surface defect from the cyclostationary contact forces, the size of the surface defect, and a prediction model.

9. The method according to claim 3, wherein the basis functions are B-splines or other functions having a local support.

10. The method according to claim 9, wherein the position parameter further comprises the angular positions of the stationary and rotating rings relative to the rolling elements, and wherein the method comprises determining the cyclostationary contact forces applied on the rotating ring.

11. The method according to claim 9, the bearing further comprising at least one cage to maintain the circumferential spacing of the rolling elements, wherein the position parameter further comprises the angular positions of the cage relative to the stationary ring, and wherein the method comprises determining the cyclostationary contact forces applied on rolling elements.

12. The method according to claim 9, wherein the position parameter further comprises the angular positions of the rolling elements relative to the stationary ring, and wherein the method comprises determining the cyclostationary contact forces applied on the stationary ring.

13. The method according to claim 12, further comprising predicting the propagation of the detected surface defect from the cyclostationary contact forces, the size of the surface defect, and a prediction model.

14. A device for estimating the size of a surface defect of a bearing, the bearing comprising a stationary ring and a rotating ring capable of rotating concentrically relative to the stationary ring, and rolling elements interposed between the stationary and rotating rings, the device comprising:
a conditioning means configured to determine strain values from signals delivered by at least one strain sensor comprising a detection cell, the length of the detection cell of the sensor in the circumferential direction being smaller than the circumferential distance between two adjacent rolling elements projected on the stationary ring, the strain values being caused by rolling element forces on the stationary ring, and to associate each strain value to at least one position parameter value comprising a rolling element position parameter representative of the position of the rolling elements relative to the at least one strain sensor,
a first determining means configured to determine intervals of position parameter values when rolling element position parameter values are associated to a maximum strain magnitude within a predetermined value, the maximum strain magnitude being equal to the maximum value of the strain values, the length of each interval being equal to a predetermined length,
a second determining means configured to determine a linear equation between the strain magnitudes of the intervals of position parameter values, a carrier function, and cyclostationary contact forces applied on at least one of the stationary ring, the rotating ring or rolling elements,
a solving means configured to solve the linear equation to determine the cyclostationary contact forces applied on said at least one of the stationary ring, the rotating ring or rolling elements,
a comparing means configured to compare the determined cyclostationary contact forces to a detection threshold,
a detecting means configured to detect a surface defect on said at least the stationary ring, the rotating ring or rolling elements if the value of the cyclostationary contact forces is smaller than the detection threshold, and
a third determining means configured to determine the size of the surface defect from the intervals of position parameter from the position parameter values associated with cyclostationary contact forces smaller than the detection threshold, the size of the surface defect comprising the depth of the said defect, the depth being determined from the minimal value of the cyclostationary contact forces.

15. A bearing device comprising:
a bearing including a stationary ring and a rotating ring capable of rotating concentrically relative to one another, and rolling elements interposed between the stationary and rotating rings,
a first strain sensor disposed on the stationary ring or on the rotating ring, the first strain sensor comprising a detection cell, the length of the detection cell of the sensor in the circumferential direction being smaller than the circumferential distance between two adjacent rolling elements projected on the stationary ring, and
a device according to claim 14 connected to the first strain sensor.

16. The bearing device according to claim 15, further comprising a second strain sensor, the at least one first strain sensor being disposed on the stationary ring and the second strain sensor being disposed on the rotating ring.
